(19) United States
(12) Patent Application Publication
(10) Pub. No.: US 2026/0233390 A1
(43) Pub. Date: Aug. 13, 2026

(54) CONTROL DEVICE AND ROBOT SYSTEM

(71) Applicant: FANUC CORPORATION, Yamanashi (JP)

(72) Inventors: Takashi SATOU, Yamanashi (JP); Wanfeng FU, Yamanashi (JP)

(21) Appl. No.: 19/156,983

(22) PCT Filed: Feb. 24, 2023
(86) PCT No.: PCT/JP2023/006872

§ 371 Date: Aug. 15, 2025

(51) Int. Cl. B25J 9/16; B25J 11/00; B25J 13/08; B25J 15/00

(52) U.S. Cl. CPC B25J 9/1633; B25J 11/006; B25J 11/0065; B25J 13/085; B25J 15/0019; G05B 2219/39001; G05B 2219/45058

(57) ABSTRACT

This control device for controlling a robot comprises: a force control unit that executes force control on the basis of a detection value of a force detector and a prescribed force control parameter; and a parameter adjustment unit that causes a robot and a machine operating together with the robot to execute a prescribed task by the force control, thereby adjusting the prescribed force control parameter and an operation parameter of the machine, the parameter adjustment unit transmitting a command value of the adjusted operation parameter to the machine.

### FIELD

The present disclosure relates to a controller and a robot system.

### BACKGROUND

A robot system configured to include an articulated robot equipped with an end effector on the tip and perform predetermined work by causing the articulated robot to operate by force control is known. For example, PTL 1 describes a robot system including an articulated robot equipped with a screw fastening driver on the arm tip and executing force control in such a way that an external force detected by a force sensor is a preset pressing force. PTL 2 describes a robot system including an articulated robot equipped with a bit as a tool (an end effector) on the tip and controlling the robot in such a way as to bring a force pressing the tool in a forward direction close to a predetermined value, based on force information detected by a force sensor.

### CITATION LIST

### Patent Literature

[PTL 1] Japanese Unexamined Patent Publication (Kokai) No. 2010-264514 A

[PTL 2] Japanese Unexamined Patent Publication (Kokai) No. 2017-127908 A SUMMARY

### TECHNICAL PROBLEM

It is preferable to suitably adjust force control parameters in order to cause a robot to execute work based on force control. However, since adjustment of the force control parameters involves a high degree of difficulty and sophisticated skill is preferred, a technology for automatically adjusting the force control parameters is desired. In a system including a robot equipped with an end effector and performing work based on force control, it is desirable to be able to adjust parameters of the end effector in addition to force control parameters at the same time. Further, work performed by causing a robot to execute force control may include work performed by a robot with another machine such as a machine tool, in addition to work performed by a robot using an end effector. Therefore, in a system configuration in which a robot executes work with another machine such as an end effector, a technology that enables adjustment of parameters of the machine operating with the robot in addition to parameters of force control by the robot is also desired.

### SOLUTION TO PROBLEM

An embodiment of the present disclosure is a controller for controlling a robot, the controller including a force control unit configured to execute force control, based on a detection value of a force detector and a predetermined force control parameter, and a parameter adjustment unit configured to adjust the predetermined force control parameter and an operating parameter of a machine operating with the robot by causing the robot and the machine to execute predetermined work based on the force control and transmit a command value of the adjusted operating parameter to the machine.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS FIG. 1 is a diagram illustrating a configuration of a robot system according to a first embodiment.

FIG. 2 is a functional block diagram of the robot system.

FIG. 3 is a diagram illustrating a first example of a screw supply method.

FIG. 4 is a diagram illustrating a second example of the screw supply method.

FIG. 5 is a flowchart of parameter adjustment processing according to the first embodiment.

FIG. 6A is a diagram illustrating an example of a position error and a posture error.

FIG. 6B is a diagram illustrating another example of a position error and a posture error.

FIG. 7 is a diagram illustrating a configuration example of using an additional axis motor as a screw fastening mechanism.

FIG. 8 is a diagram illustrating a configuration example of performing screw fastening by using a wrist axis of a robot as a screw fastening mechanism.

FIG. 9 is a functional block diagram of a robot system according to a second embodiment.

FIG. 10 is a diagram illustrating a configuration of the arm tip of a robot.

FIG. 11 is a flowchart of parameter adjustment processing according to the second embodiment.

FIG. 12 is a diagram illustrating the arm tip of a robot configured to include a grinder for deburring as a tool attached to the wrist axis of the robot and to execute deburring work.

FIG. 13 is a diagram illustrating the arm tip of a robot configured to include a rotary tool for friction stir welding as a tool attached to the wrist axis of the robot and execute friction stir welding.

FIG. 14 is a functional block diagram of a robot system according to a third embodiment.

FIG. 15 is a diagram illustrating installation of a workpiece on the principal axis of a machine tool (lathe) by force-controlled centering.

FIG. 16A is a diagram illustrating a face alignment step in the installation of the workpiece on the principal axis of the machine tool (lathe) by force-controlled centering.

FIG. 16B is a diagram illustrating an axial centering step in the installation of the workpiece on the principal axis of the machine tool (lathe) by force-controlled centering.

FIG. 17 is a diagram illustrating takeout of the workpiece from the principal axis of the machine tool (lathe) by force-controlled centering.

FIG. 18A is a diagram illustrating a face alignment step in the takeout of the workpiece from the principal axis of the machine tool (lathe) by force-controlled centering.

FIG. 18B is a diagram illustrating an axial centering step in the takeout of the workpiece from the principal axis of the machine tool (lathe) by force-controlled centering.

FIG. 19 is a diagram illustrating a configuration example of a robot performing work with a conveying device.

FIG. 20 is a flowchart of parameter adjustment processing according to the third embodiment.

FIG. 21 is a graph illustrating an example of oscillation of a force actually received by the robot as a response to force control.

FIG. 22 is a graph illustrating an example of a force actually received by the robot as a response to force control being excessive.

FIG. 23 is a graph illustrating an example of a force actually received by the robot as a response to force control being proper.

### DESCRIPTION OF EMBODIMENTS

Next, embodiments of the present disclosure will be described with reference to the drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

### First Embodiment

FIG. 1 is a diagram illustrating a configuration of robot system 100 according to a first embodiment. As illustrated in FIG. 1, robot system 100 includes robot 10, robot controller 20 controlling robot 10, and teach pendant 30 connected to robot controller 20. Screw fastener 60 as an end effector is attached to flange 11 of the wrist of robot 10 with attaching plate 51 interposed therebetween. Force sensor (force detector) 70 detecting an external force is attached between flange 11 of the wrist and attaching plate 51. In the configuration, robot system 100 can set screw fastener 60 at a desired position and a desired posture by robot 10 and execute screw fastening work by screw fastener 60 while causing robot 10 to execute force control, based on a detection value detected by force sensor 70. As will be described in detail below, robot system 100 is configured to be able to automatically adjust force control parameters for executing force control and a parameter used in the operation of screw fastener 60 at the same time.

As an example, it is assumed that robot 10 is a six-axis vertical articulated robot. It should be noted that various types of robots, such as a horizontal articulated robot, a parallel link robot, and a dual-arm robot, may be used as robot 10 depending on the target of the work. While a configuration example of robot 10 being equipped with screw fastener 60 as an end effector is illustrated in FIG. 1, various types of end effectors may be attached to robot 10 depending on the purpose of the work.

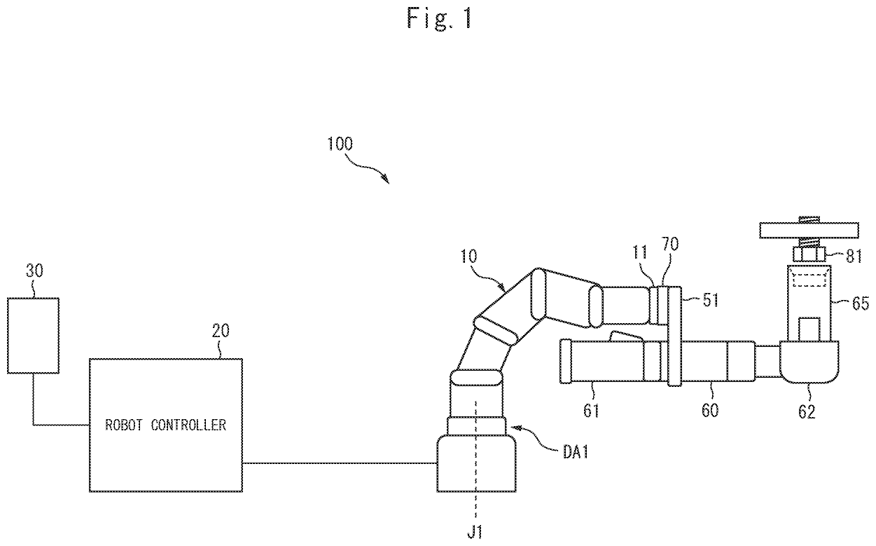

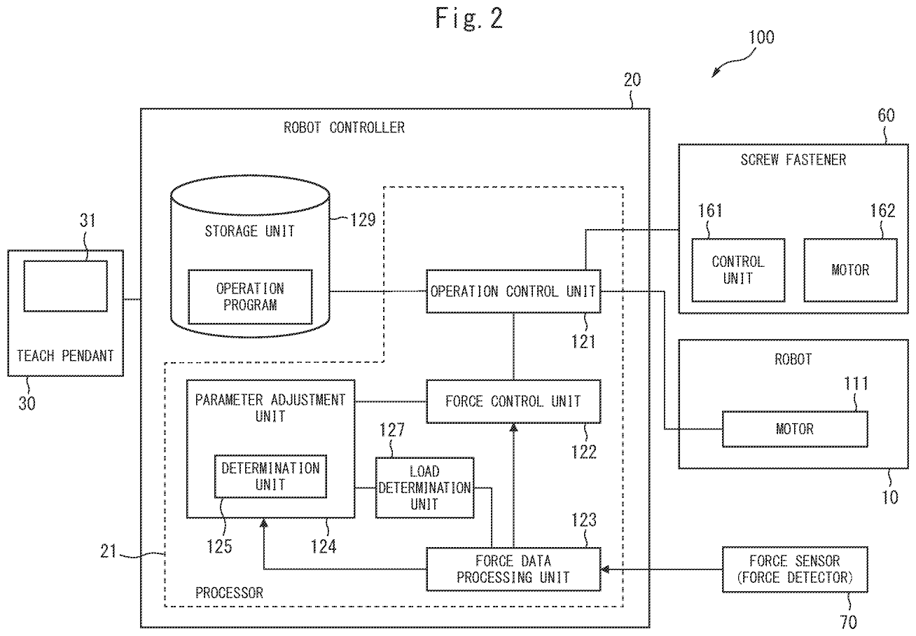

Robot controller 20 controls the operation of robot 10 in accordance with an operation program or a command from teach pendant 30. Robot controller 20 may have a hardware configuration as a common computer including processor 21 (see FIG. 2), a memory (e.g., a ROM, a RAM, or a nonvolatile memory), a storage device, an operation unit, an input-output interface, a network interface, and the like.

Teach pendant 30 is used as an operation terminal for performing teaching of robot 10 and various types of setting. A teaching device configured with a tablet computer or the like may be used as teach pendant 30. Teach pendant 30 may have a hardware configuration as a common computer including a processor, a memory (e.g., a ROM, a RAM, or a nonvolatile memory), a storage device, an operation unit, display unit 31 (see FIG. 2), an input-output interface, a network interface, and the like.

As an example, screw fastener 60 is an angle-type screw fastener (a nut runner). Screw fastener 60 includes body unit 61 inside which control unit 161 and motor 162 (see FIG. 2) are included and head unit 62 connected to the tip of body unit 61. Head unit 62 holds socket 65 as a tool. Socket 65 holds screw 81. Screw fastener 60 is connected to robot controller 20 and fastens screw 81 to a screw hole in a target object in accordance with a command from robot controller 20.

Screw fastener 60 is attached on one side of attaching plate 51, and the other side of attaching plate 51 is attached to flange 11 of robot 10. In this configuration, screw fastener 60 can be set to a desired position and a desired posture by robot 10, and screw fastening work can be executed on a target object.

For example, force sensor 70 is a six-axis force sensor detecting a force acting on each of X-, Y-, and Z-axis directions orthogonal to each other and moment around each axis. It should be noted that while an external force acting on robot 10 is detected by force sensor 70 in the present embodiment, an external force may be detected based on a detection value of a torque sensor provided on each axis of the robot in place of the force sensor.

FIG. 2 is a functional block diagram of robot system 100. As illustrated in FIG. 2, robot controller 20 includes operation control unit 121, force control unit 122, force data processing unit 123, and parameter adjustment unit 124. The functional blocks may be functional components provided by execution of a program by processor 21 in robot controller 20.

Robot controller 20 includes storage unit 129. For example, storage unit 129 is a storage device configured with a nonvolatile memory or a hard disk device. An operation program for controlling robot 10, various types of setting information including force control parameters and an operating parameter, and the like are stored in storage unit 129.

Operation control unit 121 controls the operation of robot 10 in accordance with the operation program or a command from teach pendant 30. Robot controller 20 includes a servo control unit (unillustrated) executing servo control on motor 111 on each axis in accordance with a command generated by operation control unit 121 to the axis.

Force data processing unit 123 provides a function of calculating an external force (a force and moment) acting on robot 10 (e.g. a screw mounted on the screw fastener 60), based on a detection value of force sensor 70. The position and the posture of force sensor 70 can be calculated from the position and the posture of a coordinate system at the wrist tip of robot 10 and relative position information of force sensor 70 with respect to the wrist tip. Force data processing unit 123 can calculate the magnitude of a force and moment and the directions of the force and the moment in any preset coordinate system, based on the position, the posture, and a detection value of force sensor 70.

Force control unit 122 is responsible for a function of executing force control, based on force information calculated by force data processing unit 123 and predetermined force control parameters.

Operation control unit 121 has a function of causing robot 10 to execute an operation based on force control in accordance with a command by force control unit 122.

Parameter adjustment unit 124 has a function of automatically adjusting an operating parameter of screw fastener 60 as an end effector in addition to the predetermined force control parameters. Parameter adjustment unit 124 may include determination unit 125 responsible for a function of determining whether a parameter value is suitable by determining an operating state of force control.

Screw fastener 60 includes motor 162 for rotating socket 65 and control unit 161 performing drive control of motor 162. Control unit 161 performs drive control of motor 162 in accordance with a command for an operating parameter acquired from operation control unit 121. For example, control unit 161 may be configured with a microcomputer chip incorporating a CPU, a memory (e.g., a ROM, a RAM, or a nonvolatile memory), and the like.

The automatic adjustment function for the force control parameters and the operating parameter of screw fastener 60 performed by parameter adjustment unit 124 will be described below. First, an operation technique of screw fastening based on force control using screw fastener 60 will be described; and then, a parameter adjustment operation performed by parameter adjustment unit 124 will be described.

There are two configurations of a screw supply technique as described below in the screw fastening operation.

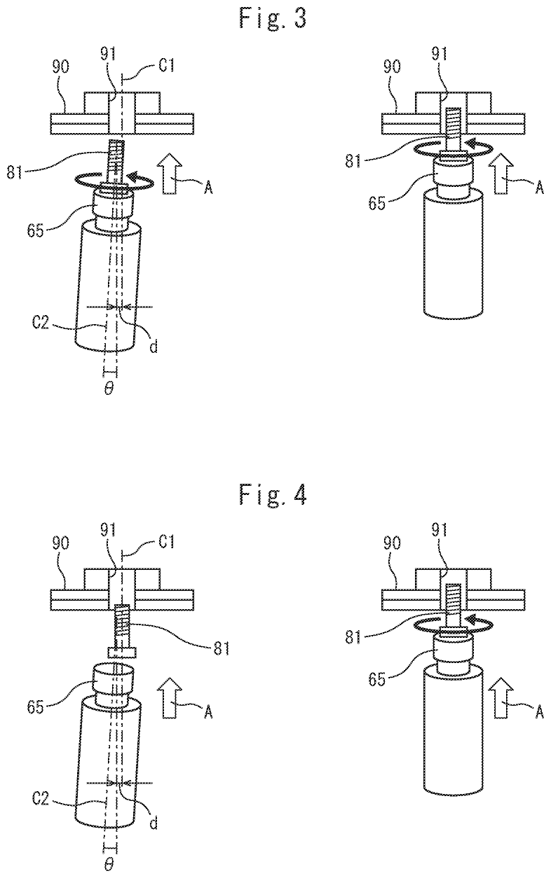

FIG. 3 is a diagram illustrating a first example of the screw supply technique in screw fastening. FIG. 3 illustrates an operational configuration in the case of previously attaching a screw to socket 65 of screw fastener 60 and performing screw fastening. Screw 81 is in the state of being previously attached to socket 65 of screw fastener 60. Socket 65 of screw fastener 60 is rotated in this state, and screw 81 is fastened to screw hole 91 in target object 90.

As illustrated on the left-hand side of FIG. 3, control of maintaining the pressing force in a pressing direction (indicated by an arrow A in FIG. 3) at a predetermined force is performed in force control in screw fastening. Further, in the force control in the screw fastening, a position error and a posture error of the screw fastener are corrected based on a detection value by force sensor 70. Then, rotation of screw fastener 60 is stopped by detecting the torque of screw fastener 60 when screw 81 is seated.

Force sensor 70 detects a reaction force received by screw 81 in the pressing direction (indicated by the arrow A in FIG. 3), i.e., a pressing force in the pressing direction. Robot controller 20 holds a setting value of the pressing force as a force control parameter. Force data processing unit 123 calculates the pressing force applied by socket 65. For example, when the pressing force of socket 65 is greater than the setting value, force control unit 122 transmits a command for correcting the operation of the wrist of robot 10 in a decreasing direction of the pressing force, and operation control unit 121 controls robot 10 in accordance with the command. A force control gain related to the pressing direction is used in correction of the pressing force based on an amount of error of the pressing force. For example, the amount of correction of the operation of robot 10 is generated by multiplying the amount of error of the pressing force by the force control gain. By such control, the pressing force during screw fastening can be maintained at the setting value.

In screw fastening based on force control, robot controller 20 can operate in such a way as to correct a position error and a posture error. A position error can be defined as a misalignment of the center of the tip of screw 81 relative to the center line C1 of screw hole 91 as denoted by a distance d in FIG. 3. A posture error can be defined as an inclination of the central axis C2 of screw 81 (socket 65) relative to the center line C1 of the screw hole as denoted by an angle θ in FIG. 3.

Robot controller 20 can correct the posture error 0 by controlling the posture of screw fastener 60 in such a way that the moment around an axis perpendicular to the forward direction of the screw approaches zero, based on force information detected by force sensor 70. Force control unit 122 generates a command for correcting the posture of robot 10 (screw fastener 60), based on the detected moment in the posture error direction and the force control gain in the posture error direction. For example, a command for correcting the posture error of robot 10 can be generated by multiplying the moment in the posture error direction (the amount of posture error) by the force control gain.

Robot controller 20 can correct the position of robot 10 in such a way that the position error d of the screw approaches zero, based on force information detected by force sensor 70. Force control unit 122 generates a command for correcting the position of robot 10 (screw fastener 60), based on a detection value of the force in the position error direction and the force control gain in the position error direction. For example, a command for correcting the position error of robot 10 can be generated by multiplying the detection value of the force in the position error direction by the force control gain. By the screw fastening operation entailing the force control as described above, the operation of suitably fastening the screw to the screw hole in the target object is achieved as illustrated on the right-hand side in FIG. 3.

FIG. 4 is a diagram illustrating a second example of the screw supply technique in screw fastening. In the second example, screw 81 is fitted into screw hole 91 in target object 90 to some degree from the beginning as illustrated in FIG. 4. In this operation example, socket 65 of screw fastener 60 is fitted into screw 81, and screw fastening is executed by rotating screw fastener 60 (socket 65).

Similarly to the aforementioned first example of the screw supply technique, control is performed in such a way that the pressing force in the pressing direction (an arrow A) is maintained at a predetermined value (a setting value) by executing force control during screw fastening. Further, correction of the position error d and the posture error 0 is performed in the force control. Then, the rotation of screw fastener 60 is stopped by detecting the torque of screw fastener 60 when screw 81 is seated. By the screw fastening operation entailing force control as described above, the operation of suitably fastening the screw to the screw hole in the target object is achieved as illustrated on the right-hand side in FIG. 4.

From the viewpoint of suitably succeeding in the screw fastening operation without causing a phenomenon such as bite of a screw during the screw fastening operation, it is important to set the following parameters to suitable values.
(1) the rotation speed of the screw
(2) the pressing force during screw fastening
(3) the force control gains (in the pressing direction, the position error correcting direction, and the posture error correcting direction)

The rotation speed of the screw out of the aforementioned parameters is an operating parameter of screw fastener 60. The pressing force during screw fastening and the force control gain are force control parameters. It is assumed that the force control gain is set for each of the pressing direction, the position error correcting direction, and the posture error correcting direction. Parameter adjustment unit 124 can execute parameter adjustment processing of automatically setting the parameters to suitable values. Parameter adjustment unit 124 provides a preset position error and a preset posture error to screw fastener 60 and searches for optimum parameters by varying the parameter values while executing the screw fastening operation. At this time, parameter adjustment unit 124 may acquire optimum parameters by performing the screw fastening operation for a plurality of types of position errors and posture errors.

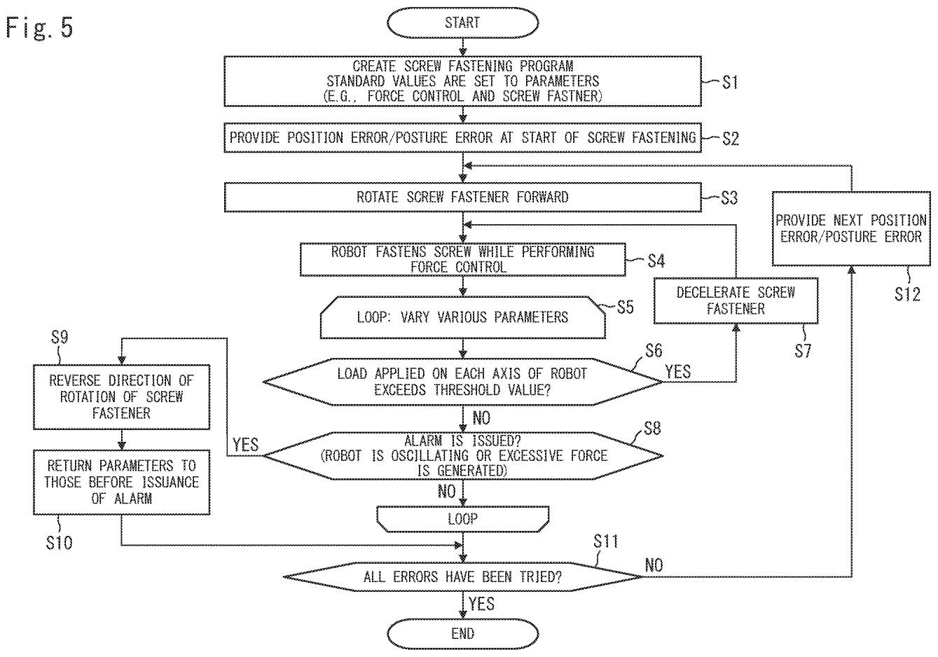

FIG. 5 is a flowchart illustrating an overall flow of the parameter adjustment processing. The parameter adjustment processing is executed under the control of parameter adjustment unit 124 (processor 21).

First, a screw fastening program is created by a user and is introduced into robot controller 20 (step S 1). In this case, standard values may be set as parameters (force control parameters and an operating parameter of screw fastener 60).

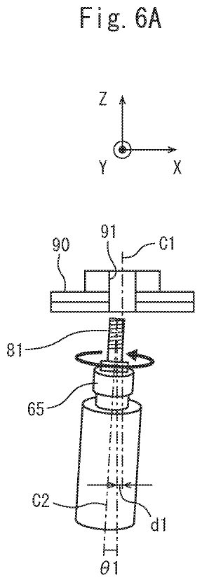

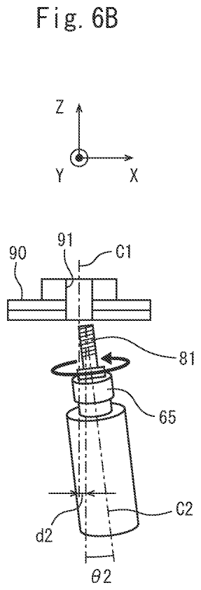

Next, parameter adjustment unit 124 provides an initial position error and an initial posture error to screw fastener 60 (step S2). For example, the position error and the posture error to be provided are those as illustrated in FIG. 6A. The errors will be described with a coordinate system including a Z-axis in a direction parallel with the center line C1 of screw hole 91 being set as illustrated in FIG. 6A. In the example in FIG. 6A, a position error dl is provided on the negative side of the center line C1 in the X-axis direction, and a posture error θ1 is provided around the Y-axis. When screw fastening is performed in this state, operation control unit 121 and force control unit 122 operate in such a way as to correct the errors by using the current force control parameters.

Operation control unit 121 rotates screw fastener 60 forward (step S3). Then, screw fastening by force control is executed (step S4). In the screw fastening operation, the operation is executed while the error is corrected by force control using the force control parameters, as described above.

Next, parameter adjustment unit 124 executes loop processing of performing checks in steps S6 and S8 while varying values of various force control parameters during operation of the force control (step S5). The behavior of robot 10 may be checked by varying the values of the parameters toward preset upper limits (or lower limits).

Parameter adjustment unit 124 confirms whether the load applied on each axis of robot 10 exceeds a threshold value while robot 10 executes the screw fastening based on force control (step S6). When any of the loads applied on the axes of the robot exceeds the threshold value (S6: YES), parameter adjustment unit 124 decreases the rotation speed of screw fastener 60 and continues the operation (step S7). At this time, parameter adjustment unit 124 transmits a command value of the rotation speed to screw fastener 60 through operation control unit 121. By the processing in steps S6 and S7, the load applied on each axis is adjusted toward a proper value by decreasing the rotation speed of screw fastener 60 when the load applied on the axis is excessive. When the load applied on each axis does not exceed the threshold value (S6: NO), the processing advances to step S8.

For example, the load applied on robot 10 is calculated by the following technique by load determination unit 127. Storage unit 129 stores allowable values (threshold values) for a plurality of directional components for each load acting on each joint. For example, as the allowable values, for joint axis J1 of first joint DA1, storage unit 129 stores allowable values of the force in a direction along joint axis J1, the moment around joint axis J1, the force in any direction orthogonal to joint axis J1, and the moment around any axis orthogonal to joint axis J1. Each allowable value may be set based on the load capacities or the like of a motor, a reduction gear, and a bearing at each joint. Load determination unit 127 calculates the load acting on each joint, based on components of the force and the moment detected by force sensor 70 and posture information (rotational position information of each joint) of robot 10 when the force is detected. Load determination unit 127 may calculate the force and the moment of components of the load in a plurality of directions acting on each joint. By comparing the force and the moment for the plurality of directions found for each joint axis with the allowable values for the force and the moment in a plurality of directions, the values being stored in storage unit 129, load determination unit 127 can determine whether the load at each axis exceeds the threshold value. When any of the force and the moment for the plurality of directions exceeds the allowable value for a certain joint axis, load determination unit 127 may determine that the force acting on the axis exceeds the allowable value.

In step S8, parameter adjustment unit 124 confirms whether an alarm, such as oscillation of robot 10, generation of an excessive force in robot 10, or the like, is issued. When the force control parameters are not suitable, a phenomenon in which the force (the force or the moment) actually applied to the robot as a response to force control oscillates or exceeds the threshold value and becomes excessive, may occur. Whether such an alarm is issued is determined in step S8. The determination function may be provided as a function of determination unit 125 in parameter adjustment unit 124.

When an alarm is issued (i.e., when the current parameters are not suitable) (S8: YES), robot controller 20 reverses the direction of rotation of screw fastener 60 (step S9) and returns the various parameters to the state before the issuance of the alarm (step S10). Then, the processing advances to step S11.

When an alarm is not issued (S8: NO) and the loop processing has ended, the current parameters are proper. In this case, parameter adjustment unit 124 confirms whether all of a plurality of types of errors have been tried (step S11). When not all the errors have been tried (S11: NO), parameter adjustment unit 124 provides next errors to robot 10 (step S12) and executes the screw fastening operation from step S3 again.

For example, next errors are those as illustrated in FIG. 6B. The same coordinate system as the coordinate system defined in FIG. 6A is defined in FIG. 6B. In the example in FIG. 6B, a position error d2 is provided on the positive side of the center line C1 in the X-axis direction, and a posture error θ2 (a posture error in a direction opposite to 01 with reference to the center line C1) is provided around the Y-axis. Thus, robot controller 20 can prepare a plurality of types of position errors in the X-axis direction and the Y-axis direction and a plurality of types of posture errors around the Y-axis and around the X-axis and use the errors in the parameter adjustment processing.

When the operation is performed for all of the plurality of types of errors (S11: YES), the parameter adjustment processing ends.

The parameter adjustment processing described above enables a search for proper parameters for the force control parameters and the operating parameter of screw fastener 60, i.e., adjustment to proper parameters.

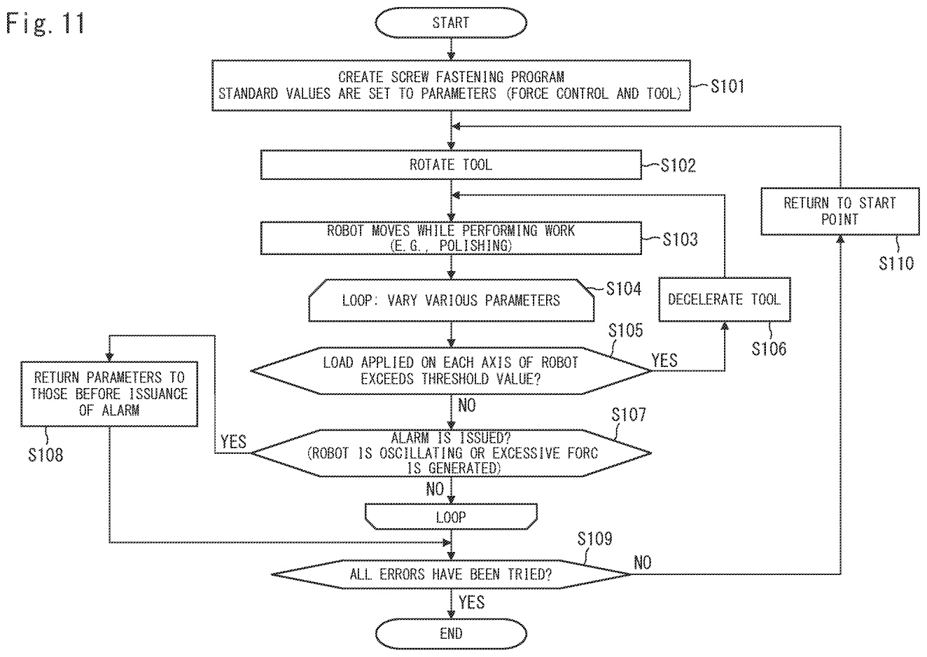

It should be noted that, when parameters are varied in the loop processing in step S5, all parameters being targets of the search may be varied, or one of a plurality of parameters may be varied. When one parameter is varied in the loop processing in step S5, all the parameters may be adjusted by performing the parameter adjustment processing in FIG. 11 on each of the plurality of parameters.

Parameter adjustment as described below can be specifically performed by applying the aforementioned parameter adjustment processing. The rotation speed of screw 81 during screw fastening may be determined to be a certain value, based on a criterion of satisfying a cycle time of screw fastening. Therefore, the rotation speed of the screw to be set in step S1 may be the value determined based on the criterion. Then, screw fastening is performed while the force control gain is varied (the loop processing in step S5), and a search for a suitable force control gain is performed. An actual response of force to a command value for force may be confirmed, and the search may be performed until a suitable response is acquired.

A command value for force is a target pressing force with respect to the pressing direction. Robot 10 is controlled in such a way that the pressing force becomes the target pressing force in force control. When the force control gain with respect to the pressing direction is too large, a change in the actual pressing force as a response to the command becomes oscillatory or excessive, which is not suitable in terms of operating stability. On the other hand, when the force control gain is small, the response of the actual pressing force is delayed and cannot follow the moving screw. A suitable force control gain is to be acquired from the viewpoint of stability and response speed. The value of a command value for force is zero with respect to the position error direction; and when the robot receives a force with respect to the position error direction in force control, the robot is controlled in such a way that the force received by robot 10 decreases. When the force control gain is too large, the response of force becomes oscillatory or excessive, which is not suitable in terms of operating stability. On the other hand, when the force control gain is small, the response is delayed, and the time for screw 81 to enter screw hole 91 increases. A suitable force control gain is to be acquired from the viewpoint of stability and response speed. Further, a command value for force related to the posture error direction is a command value for the moment received by robot 10 with respect to the posture error direction, and the value is zero. Robot 10 is controlled in such a way that the moment received by robot 10 with respect to the posture error direction decreases. When the force control gain is too large, the response of the moment becomes oscillatory or excessive, which is not suitable in terms of operating stability. On the other hand, when the force control gain is small, the response is delayed, and the time for screw 81 to enter screw hole 91 increases. A suitable force control gain is to be acquired from the viewpoint of stability and response speed.

As for adjustment of the pressing force, a maximum value of the pressing force is to be predetermined from the viewpoint of possible damage to the screw thread when the pressing force is too large. Then, in the search for the pressing force (the loop processing in step S5), a minimum pressing force that allows the operation of the robot to follow screw fastening can be found by gradually decreasing the pressing force. The value is set as a suitable pressing force.

The rotation speed of the screw may be adjusted to a suitable value in the process of executing the parameter adjustment processing in FIG. 5. Slight correction adjusted to progress of screw fastening may be performed on the rotation speed of the screw after the parameter adjustment processing in FIG. 5. As an example, adjustment causing decrease in the rotation speed is performed in the initial stage of screw fastening. Since the posture error is relatively large immediately after the start of screw fastening, responsiveness of the force control can be brought to a satisfactory state by keeping the rotation speed low.

Two configuration examples of a screw fastening mechanism equipped on robot 10 as an end effector other than use of screw fastener 60 will be described.

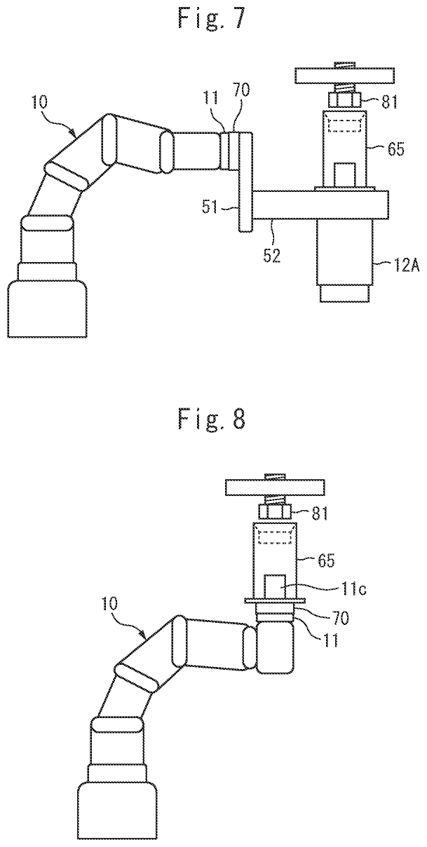

FIG. 7 illustrates a configuration example of using an additional axis motor as a screw fastening mechanism. As illustrated in FIG. 7, additional axis motor 12A is fixed to attaching plate 51 attached to flange 11 of the wrist with holding plate 52 interposed therebetween. Socket 65 is fixed to the drive shaft of additional axis motor 12A. By rotation of additional axis motor 12A, screw 81 can be rotated and be fastened to the screw hole in a target object. By controlling the position of flange 11 of the wrist of robot 10, the position and the posture of socket 65 on additional axis motor 12A can be set to a desired state. For example, force sensor 70 is arranged between flange 11 and attaching plate 51.

In this configuration example, a screw fastening mechanism including additional axis motor 12A and socket 65 can be positioned as an end effector.

Since a configuration equivalent to that of robot controller 20 illustrated in FIG. 2 can also be used as a robot controller in this configuration example, this configuration example will be described by using FIG. 2. In this configuration example, robot controller 20 controls the rotation speed of additional axis motor 12A as the rotation speed of a screw.

Parameter adjustment unit 124 can adjust the screw fastening rotation speed of additional axis motor 12A, the pressing force of the screw, and the force control gains (in the pressing direction, the position error correcting direction, and the posture error correcting direction) by executing the parameter adjustment processing illustrated in FIG. 5 under the screw fastening operation using additional axis motor 12A.

With this configuration, a suitable screw fastening operation based on force control can be performed by automatically adjusting parameters, similarly to the aforementioned description of the configuration using screw fastener 60.

FIG. 8 illustrates a configuration example of performing screw fastening by using wrist axis 11c of robot 10 in place of screw fastener 60 and an additional axis motor. In this example, socket 65 is attached to wrist axis 11c being the drive shaft of the wrist of robot 10, and screw fastening is executed by rotation of wrist axis 11c, as illustrated in FIG. 8. Force sensor 70 is arranged between flange 11 and socket 65.

In this configuration example, a screw fastening mechanism including wrist axis 11c and socket 65 can be positioned as an end effector. Alternatively, the socket attached to wrist axis llc may be positioned as an end effector.

Since a configuration equivalent to that of robot controller 20 illustrated in FIG. 2 can also be used as a robot controller in this configuration example, this configuration example will be described by using FIG. 2. In this configuration example, robot controller 20 controls the rotation speed of wrist axis 11c as the rotation speed of screw 81.

Parameter adjustment unit 124 can adjust the screw fastening rotation speed of wrist axis 11c, the pressing force of the screw. and the force control gains (in the pressing direction, the position error correcting direction, and the posture error correcting direction) by executing the parameter adjustment processing illustrated in FIG. 5 under the screw fastening operation using wrist axis 11c.

With this configuration, a suitable screw fastening operation based on force control can be performed by automatically adjusting parameters, similarly to the aforementioned description of the configuration using screw fastener 60.

### Second Embodiment

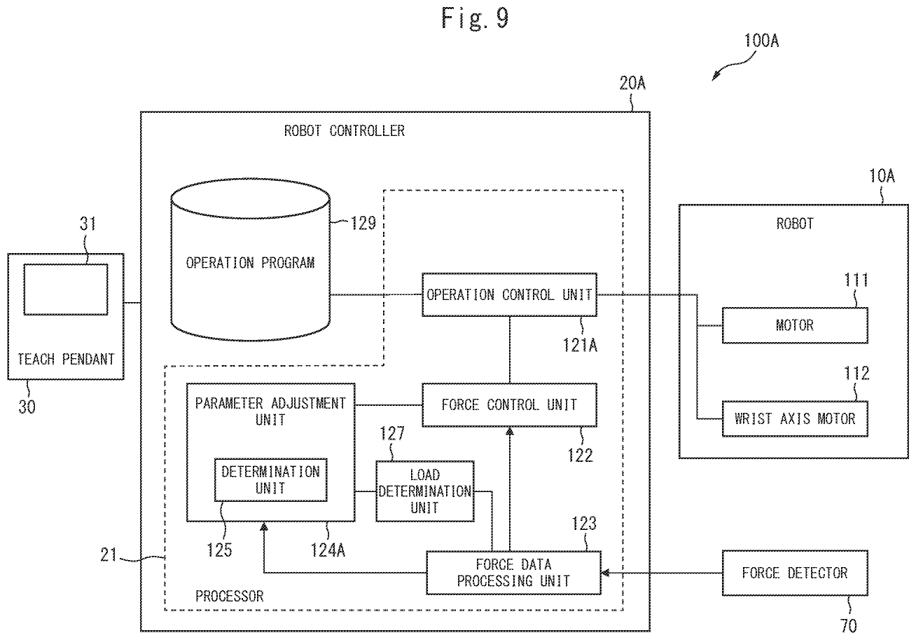

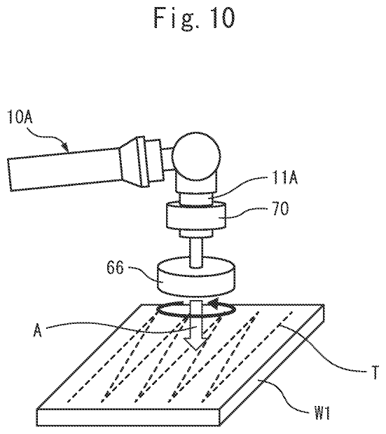

Robot system 100A performing polishing work as a robot system performing work using an end effector under force control will be described below. FIG. 9 illustrates functional blocks of robot system 100A according to the present embodiment. In FIG. 9, the same functional block or component as that in robot system 100 illustrated in FIG. 2 is indicated by giving the same sign, FIG. 10 illustrates a configuration of the arm tip of robot 10 in robot system 100. In the configuration of robot system 100A according to the present embodiment, tool 66 for polishing (a sander or a buff) is rotatably attached to flange 11A of the wrist of robot 10A as an end effector. Force sensor 70 is arranged between flange 11A and tool 66.

Robot controller 20A executes polishing work of moving tool 66 for polishing in accordance with an operation program for polishing in such a way that the tool draws a trace T on the surface of target object W1 while being rotated. The operation program for performing the polishing work is previously created and is loaded into storage unit 129 in robot controller 20A.

Robot controller 20A can adjust parameters by causing robot 10 to perform a polishing operation while providing errors to robot 10.

Parameter adjustment unit 124A automatically adjusts the following parameters.
(1) the rotation speed of tool 66
(2) the pressing force during polishing
(3) the force control gain (in the pressing direction)

As illustrated in FIG. 9, robot controller 20A according to the present embodiment has functions equivalent to those of robot controller 20 according to the first embodiment. Operation control unit 121 according to the present embodiment controls the rotation speed of wrist axis motor 112 in robot 10 as control of the screw rotation speed in a screw fastening operation. It should be noted that, while a configuration example of rotating tool 66 by driving wrist axis motor 112 is described, robot 10A may be configured to be equipped with an additional axis motor and rotate tool 66 by the additional axis motor.

FIG. 11 illustrates a flowchart of parameter adjustment processing executed under the control of parameter adjustment unit 124A (processor 21) according to the present embodiment. A search for suitable parameters is performed by varying parameters while causing robot 10A to perform polishing work in the present embodiment as well. It should be noted that it is assumed in the present embodiment that errors are not provided.

As illustrated in FIG. 11, first, a program for polishing may be created by a user and be introduced into robot controller 20 (step S101). Standard values may be set as parameters (force control parameters and a parameter of tool 66).

Next, robot controller 20A rotates tool 66 (step S102). Next, robot controller 20A executes the polishing work of moving robot 10 while causing robot 10A to execute the polishing work (step S103). Robot 10 performs the polishing work while moving along a programmed trace T, as illustrated in FIG. 10.

Next, parameter adjustment unit 124A executes loop processing of performing checks in steps S105 and S107 while varying values of various force control parameters during execution of work by force control (step S104). The behavior of robot 10A may be checked by varying the values of the parameters toward preset upper limits (or lower limits).

When any of the loads applied on axes of robot 10A exceeds a threshold value while robot 10A executes the work (S105: YES), parameter adjustment unit 124A decreases the rotation speed of tool 66 and continues the operation (step S106). By the processing in steps S105 and S106, the rotation speed of tool 66 is adjusted. When the load applied on each axis does not exceed the threshold value (S106: NO), the processing advances to step S107.

In step S107, parameter adjustment unit 124A confirms whether an alarm, such as oscillation of robot 10A or generation of an excessive force in robot 10A, is issued. When the force control parameters are not suitable, a phenomenon in which the force (the force or the moment) actually applied to the robot as a response to force control oscillates or exceeds a threshold value and becomes excessive, may occur. Whether such an alarm is issued is determined in step S107. The determination function may be provided as a function of determination unit 125 in parameter adjustment unit 124A.

When an alarm is issued (i.e., when the current parameters are not suitable) (S107: YES), parameter adjustment unit 124A retums the various parameters to the state before the issuance of the alarm (step S108). Then, the processing advances to step S109.

When an alarm is not issued (S107: NO) and the loop processing has ended, the current parameters are proper. In this case, parameter adjustment unit 124A confirms whether all of a plurality of types of errors have been tried (step S109). When not all the errors have been tried (S109: NO), robot 10A (tool 66) is returned to the start point of the polishing work (S110), and the operation from step S102 is executed again.

It should be noted that, when parameters are varied in the loop processing in step S104, all parameters being targets of the search may be varied or one of a plurality of parameters may be varied. When one parameter is varied in the loop processing in step S104, all the parameters may be adjusted by performing the parameter adjustment processing in FIG. 11 for each of the plurality of parameters.

The parameter adjustment processing described above enables a search for proper parameters for the force control parameters and the operating parameter of tool 66, i.e., adjustment to proper parameters.

Robot system 100A according to the second embodiment is configured to adjust parameters in the case of performing polishing work by using tool 66 for polishing. Two modified examples of the second embodiment related to work using a tool will be described.

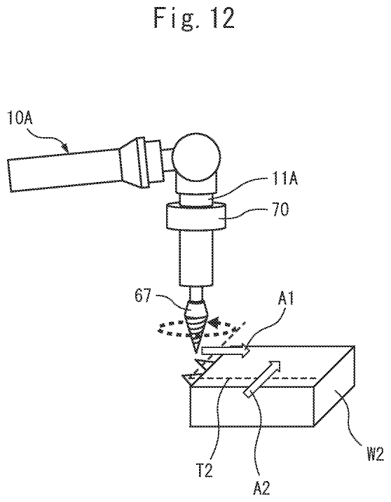

FIG. 12 illustrates the arm tip of robot 10A configured to include grinder 67 for deburring attached to the wrist axis of the robot as a tool and to execute deburring work. In this configuration, grinder 67 is attached to flange 11A of the wrist of robot 10A in a state of being rotatable by rotation of the wrist axis. Force sensor 70 is arranged between flange 11A and grinder 67.

Since the configuration in this example is equivalent to that illustrated in FIG. 9, functions of this example will be described with reference to FIG. 9. It should be noted that, while grinder 67 is rotated by driving wrist axis motor 112 in this example, robot 10A may be configured to be equipped with an additional axis motor and rotate grinder 67 by the additional axis motor.

As illustrated in FIG. 12, robot 10A operates in accordance with a program for deburring in such a way as to move grinder 67 along a trace T2 on target workpiece W2 and remove burrs on edge lines of target workpiece W2. In a process of processing an edge line of target workpiece W2 on the upper left side in the diagram, force control of pressing grinder 67 in a pressing direction indicated by an arrow A1 in the diagram is executed. In a process of processing an edge line of target workpiece W2 on the front side in the diagram, force control of pressing grinder 67 in a pressing direction indicated by an arrow A2 in the diagram is executed.

In this example, parameter adjustment unit 124A adjusts the following parameters.
(1) the rotation speed of the grinder
(2) the pressing force during deburring
(3) the force control gain (in the pressing direction)

Processing for adjusting parameters in this example is equivalent to the parameter adjustment processing illustrated in FIG. 11. In this example, grinder 67 is rotated as a tool (step S102), and, while the robot is moved along a trace based on a command in a deburring program (step S103), a search is performed by varying parameters (the loop processing in step S104).

A search for proper parameters for the force control parameters and the operating parameter of the tool, i.e., adjustment to proper parameters can also be performed in this example, similarly to the aforementioned description related to the second embodiment.

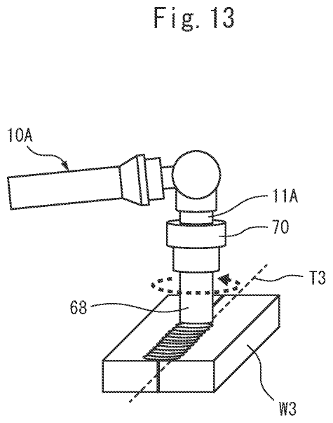

FIG. 13 illustrates the arm tip of robot 10A configured to include rotary tool 68 for friction stir welding attached to the wrist axis of robot 10A as a tool and execute friction stir welding. In this configuration, rotary tool 68 is attached to flange 11A of the wrist of robot 10A in a state of being rotatable by rotation of the wrist axis. Force sensor 70 is arranged between flange 11A and rotary tool 68.

Since the mechanism configuration in this example is equivalent to that illustrated in FIG. 9, functions of this configuration will be described with reference to FIG. 9. It should be noted that, while rotary tool 68 is rotated by driving wrist axis motor 112 in this example, robot 10A may be configured to be equipped with an additional axis motor and rotate rotary tool 68 by the additional axis motor.

As illustrated in FIG. 13, robot 10A operates in accordance with a work program for friction stir welding in such a way as to move rotary tool 68 along a trace T3 on target workpiece W3 and perform friction stir welding. In force control in this case, the force control is performed in a pressing direction in which the rotary tool is pressed against the target workpiece T3.

In this configuration example, parameter adjustment unit 124A adjusts the following parameters.
(1) the rotation speed of the rotary tool
(2) the pressing force during friction stir welding
(3) the force control gain (in the pressing direction)

Processing for adjusting parameters is equivalent to the parameter adjustment processing illustrated in FIG. 11 in this example as well. In this configuration example, rotary tool 68 is rotated (step S102), and while the robot is moved along a trace based on a command in a program for friction stir welding (step S103), a search is performed by varying parameters (the loop processing in step S104).

A search for proper parameters for force control parameters and an operating parameter of the tool, i.e., adjustment to proper parameters can also be performed in this example, similarly to the aforementioned description related to the second embodiment.

### Third Embodiment

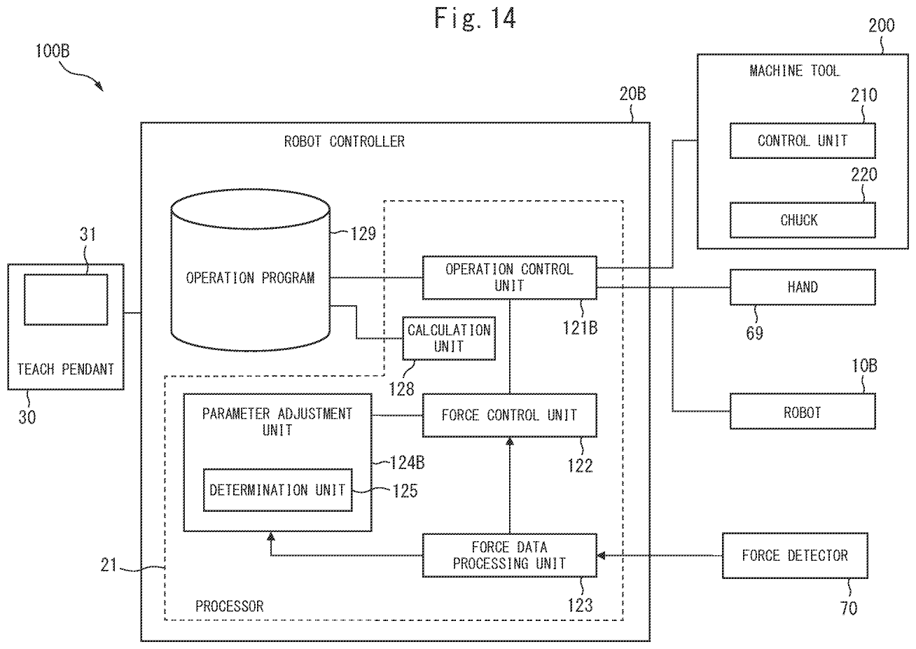

Robot system 100B according to a third embodiment will be described below. FIG. 14 illustrates a configuration diagram of robot system 100B according to the present embodiment. In FIG. 14, the same component or functional block as that in robot system 100 according to the first embodiment illustrated in FIG. 2 is given the same sign. In robot system 100B according to the present embodiment, robot 10B can execute work of mounting a workpiece on the principal axis of machine tool 200. It should be noted that a lathe will be described below as an example of a machine tool. By performing force control, the robot performs work for suitably attaching a workpiece to the principal axis of machine tool 200 in coordination with machine tool 200.

Robot controller 20B has a configuration equivalent to that of robot controller 20 according to the first embodiment in the present embodiment as well. Robot controller 20B is connected to machine tool 200 and can provide a command value for an operating parameter of chuck 220 to machine tool 200. Control unit 210 in machine tool 200 can control the operation of machine tool 200 in accordance with a command from robot controller 20B. Control unit 210 according to the present embodiment controls the operating speed of chuck 220 in accordance with a command value of the operating speed of chuck 220 from robot controller 20B. In a force-controlled centering operation, robot controller 20B executes force control, based on a detection value of force sensor 70 and can adjust parameters of force control and an operating parameter of the chuck.

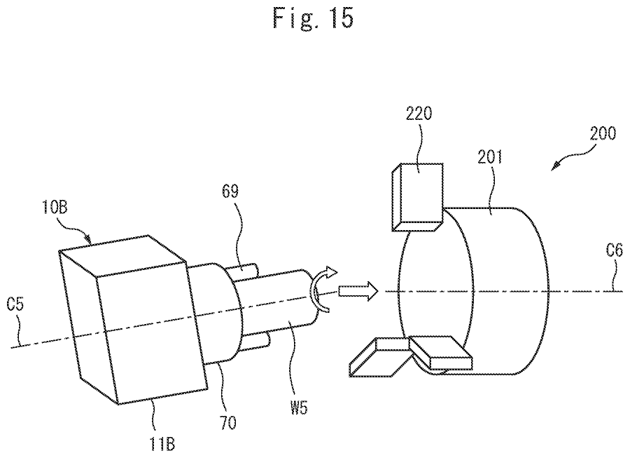

The operation of force-controlled centering will be described with reference to FIG. 15. Robot 10 holds cylindrical workpiece W5 with hand 69 attached to wrist 11B. Force sensor 70 is arranged between hand 69 and wrist 11B, and robot controller 20B can detect a force applied to the held workpiece W5. Robot 10B moves the held workpiece W5 in such a way that workpiece WS can be mounted on principal axis 201 of machine tool 200, and machine tool 200 holds workpiece W5 on principal axis 201 by closing chuck 220. The operation of closing chuck 220 is performed by robot 10B and machine tool 200 in coordination with each other in such a way that workpiece W5 is mounted in a state where the shaft center C5 of workpiece W5 matches the shaft center C6 of principal axis of the machine tool. Such a centering operation based on force control is hereinafter also referred to as force-controlled centering.

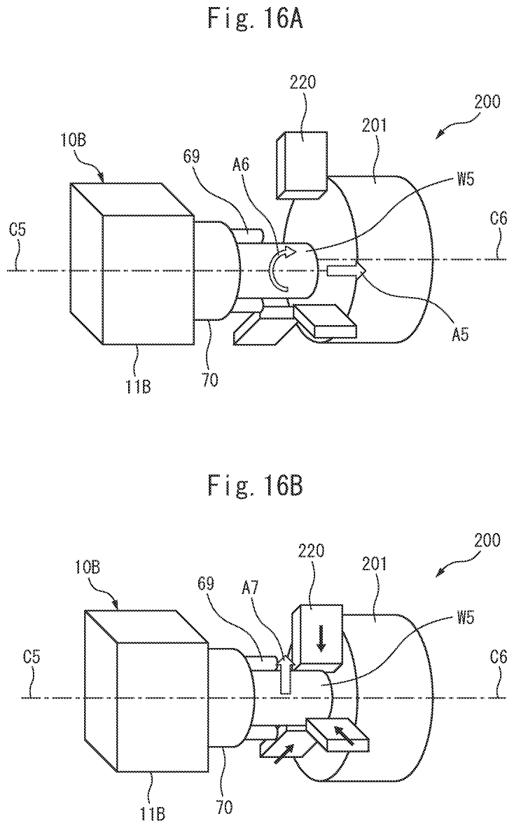

Force-controlled centering for installing workpiece W5 on machine tool 200 includes a face alignment step and an axial centering step as illustrated in FIG. 16A and FIG. 16B. The face alignment step (FIG. 16A) is a process of performing face alignment between an end face of workpiece W5 and an end face of principal axis 201 of machine tool 200. The face alignment is performed by force control by using parameters such as a pressing force pressing workpiece W5 against principal axis 201, an approaching speed of workpiece W5 toward principal axis 201, a force control gain in the pressing direction, and a force control gain in a direction of posture error correction. An arrow A5 in FIG. 16A indicates the pressing direction by the pressing force, and an arrow A6 indicates an example of a direction of posture error adjustment.

Next, in the axial centering step (FIG. 16B), axial centering between workpiece W5 and principal axis 201 is performed by closing chuck 220. In the control, an operation of closing chuck 220 at a closing speed of chuck 220 as a parameter is performed. When workpiece W5 receives a force from chuck 220 in a direction perpendicular to the shaft center C5 direction by the operation of chuck 220, robot controller 20B flexibly moves workpiece W5 (in a direction of an arrow A7 illustrated in the diagram). The axial centering between workpiece W5 and principal axis 201 is performed by force control using parameters such as a force control gain in the direction of position error correction and the operating speed of chuck 220.

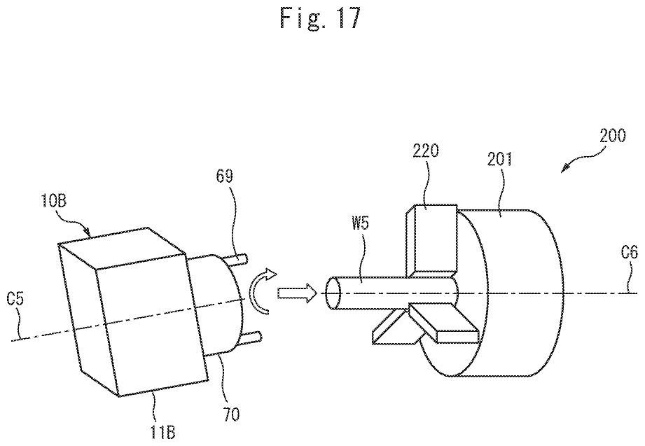

Robot controller 20B is also configured to take out a workpiece by force-controlled centering. In takeout of a workpiece by force-controlled centering, robot controller 20B executes an operation of taking out workpiece W5 mounted on principal axis 201 of machine tool 200 while performing centering based on force control, as illustrated in FIG. 17.

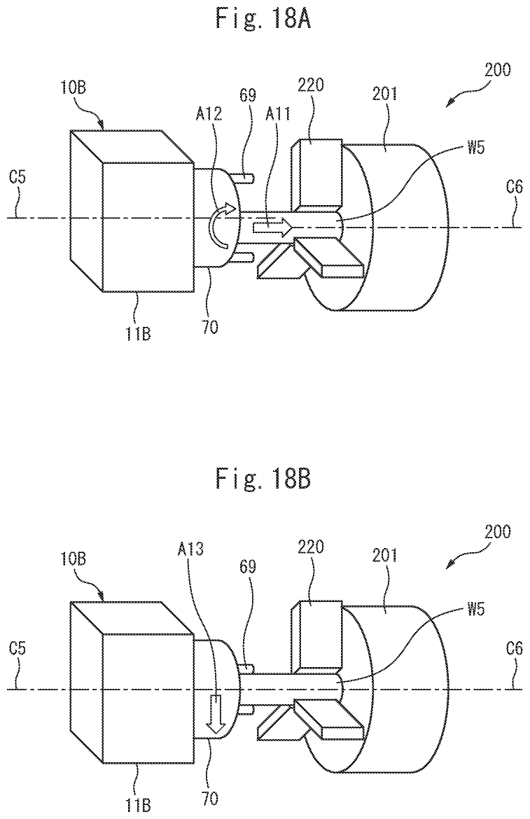

As illustrated in FIG. 18A and FIG. 18B, the takeout operation based on force-controlled centering includes a face alignment step and an axial centering step. The face alignment step (FIG. 18A) is a process of performing face alignment between the base unit of hand 69 (or an end face of force sensor 70) and an end face of workpiece W5 mounted on principal axis 201. Face alignment is performed by force control by using parameters such as a pressing force pressing hand 69 against workpiece W5, an approaching speed toward workpiece W5, a force control gain in the pressing direction, and a force control gain in a direction of posture error correction, An arrow All in FIG. 18A indicates the pressing direction by the pressing force, and an arrow A12 indicates an example of a direction of posture error adjustment.

Next, in the axial centering step (FIG. 18B), axial centering between hand 69 and principal axis 201 is performed by closing hand 69. In the control, an operation of closing hand 69 at a closing speed of hand 69 as a parameter is performed. When a force is received in the direction perpendicular to the shaft center C5 direction by the operation of closing hand 69, robot controller 20B flexibly moves hand 69 (in a direction of an arrow A13 illustrated in the diagram). Axial centering between hand 69 and principal axis 201 is performed by force control using parameters such as the force control gain in the direction of position error correction and the closing speed of hand 69.

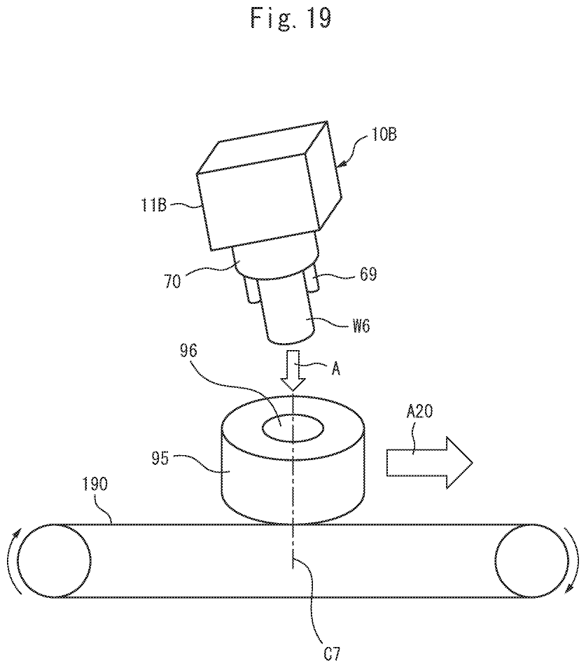

Another configuration example of the robot performing work in coordination with another machine will be described with reference to FIG. 19. In this example, robot 10B performs work of inserting cylindrical workpiece W6 into hole 96 in workpiece (fitted workpiece) 95 conveyed on conveying device 190. In this work, insertion work is performed by utilizing parameters such as a pressing force pressing cylindrical workpiece W6 (a pressing force in a direction indicated by an arrow A in the diagram), the insertion speed of inserting cylindrical workpiece W6 into hole 96, and the operating speed of conveying device 190. For example, robot controller 20B can control an operation of robot 10B following movement of workpiece 95 by using a parameter of the operating speed of conveying device 190.

Since the configuration as a robot system is equivalent to the configuration illustrated in FIG. 14 in this example as well except that conveying device 190 is used in place of machine tool 200, this example will be described with reference to FIG. 14. Workpiece W6 is held by hand 69 attached to wrist 11B of robot 10B. Force sensor 70 is arranged between wrist 11B and hand 69.

Parameter adjustment unit 124B is configured to automatically adjust an operating parameter of conveying device 190 operating in coordination with the robot in addition to force control parameters of robot 10B. In this configuration example, parameter adjustment unit 124B automatically adjusts the following parameters.
(1) the pressing force
(2) the insertion speed
(3) the operating speed of the conveying device

Parameter adjustment unit 124B can execute fitting work based on force control by using parameters such as the pressing force, the insertion speed, and the operating speed of the conveying device while correcting a position error and a posture error of workpiece W6 relative to workpiece 95.

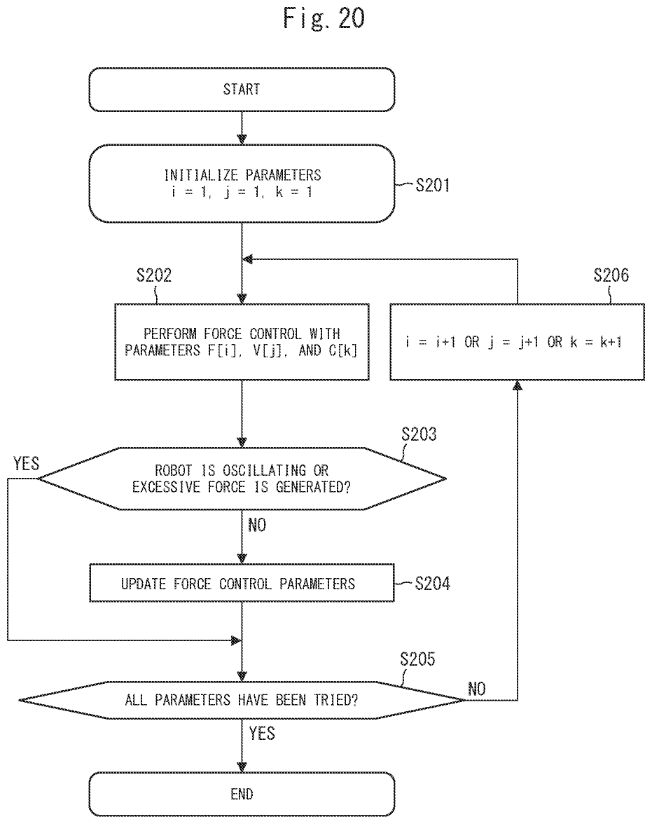

FIG. 20 is a flowchart illustrating parameter adjustment processing by robot controller 20B (processor 21) according to the third embodiment. The parameter adjustment processing will be described with reference to FIG. 20. As a specific example, parameter adjustment when robot 10B and machine tool 200 perform force-controlled centering in coordination with each other will be described. At execution of the parameter adjustment processing, candidates of parameter values are prepared as follows.
pressing force: F[1]=5 N, F[2]=10 N, F[3]=15 N, . . .
insertion speed: V[1]=1 mm/s, V[2]=2 mm/s, V[3]=3 mm/s, . . .
chuck closing speed: C[1]=10 mm/s, C[2]=20 mm/s, C[3]=30 mm/s, . . .

First, in step S201, the index of each parameter variable is initialized. Next, in step S202, work based on force control is executed by using parameters F[i], V[i], and C[k] (step S202). For example, the work of installing workpiece W5 on principal axis 201 of machine tool 200 by force-controlled centering described with reference to FIGS. 16A and 16B is performed.

Next, in step S203, parameter adjustment unit 124B confirms whether a phenomenon of oscillation of the robot or application of an excessive force to the robot has occurred. The function may be provided as a function of determination unit 125. When phenomena of oscillation of robot 10B and application of an excessive force to robot 10B have not occurred in the operation based on force control (S203: NO), parameter adjustment unit 124B updates the parameters with the current parameters F[i], V[j], and C[k] (step S205). On the other hand, when a phenomenon of oscillation of the robot or application of an excessive force to the robot has occurred in the operation based on force control (S203: YES), the processing advances to step S205 without parameter updates.

In step S205, parameter adjustment unit 124B confirms whether all parameters have been tried. When not all the parameters have been tried (S205: NO), parameter adjustment unit 124B increments the indices of the parameter variables (step 206) and repeats the processing from step S202. It should be noted that, in increment of indices of the parameter variables in step S206, one of i, j, and k may be incremented.

When all the parameters have been tried (S205: YES), the parameter adjustment processing ends.

The following operation can be provided as an example by the aforementioned parameter adjustment processing. For example, processing utilizing F[1], V[1], and C[1] in a first operation and F[1], V[2], and C[2] in a second operation can be performed.

The details relating to the determination in step S203 will now be described. Satisfaction of all of the following conditions during the force-controlled centering operation indicates a satisfactory operation, i.e., the parameters can be determined as being suitable. Dissatisfaction of one of the following conditions indicates an unsatisfactory operation, i.e., parameters can be determined as being unsuitable.
Condition 1: the robot is not oscillating.
Condition 2: excessive force or moment has not occurred.

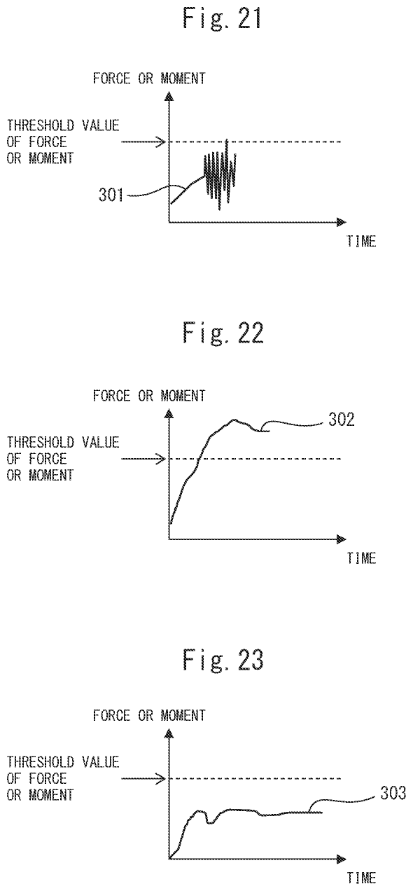

Determination of the condition 1 will be described with reference to a graph in FIG. 21. In FIG. 21, the horizontal axis represents the time, and the vertical axis represents the actual force received by robot 10B as a response to force control. The response can be acquired from a detection value of force sensor 70. As illustrated in FIG. 21, a phenomenon of oscillation of the force received by robot 10B as a response to the force control is determined as being oscillation of robot 10B. A phenomenon of occurrence of oscillation of robot 10B appears in a graph 301 in FIG. 21.

Determination of the condition 2 will be described with reference to a graph in FIG. 22. In FIG. 22, definitions of the horizontal axis and the vertical axis are similar to those in FIG. 21. A graph 302 indicates that the force received by robot 10B exceeds a threshold value and is excessive. Thus, when the force received by robot 10B exceeds the threshold value, the force or the moment received by robot 10B can be determined as being excessive.

FIG. 23 illustrates a case of the force or the moment received by robot 10B as a response to force control not oscillating and not exceeding the threshold value. It should be noted that definitions of the horizontal axis and the vertical axis in a graph 303 in FIG. 23 are similar to those in FIG. 21. In this case, parameters are satisfactory, and both the condition 1 and the condition 2 can be determined as being satisfied.

When both the condition 1 and the condition 2 are satisfied, as is the case in FIG. 23, the centering operation is determined as being satisfactory, and the force control parameters are updated with parameters at that time. On the other hand, when either one of the condition 1 and the condition 2 is not satisfied, the centering operation is determined as being unsatisfactory, and the force control parameters are not updated.

For example, when a satisfactory response in FIG. 23 is acquired with F[3], V[2], and C[2], and an unsatisfactory response in FIG. 21 or FIG. 22 is acquired with F[3], V[2], and C[3], parameter adjustment unit 124B updates the parameters to F[3], V[2], and C[2].

As described above, in force-controlled centering for mounting a workpiece on a principal axis, automatic adjustment can be performed with the pressing force F, the insertion speed V, and the closing speed C of the chuck as parameters.

In force-controlled centering for taking out a workpiece from a principal axis, the parameter adjustment processing described above enables automatic adjustment with the pressing force, the insertion speed, and the closing speed of the hand as parameters.

Further, in force control of robot 10B fitting workpiece W6 to workpiece 95 conveyed on conveying device 190 described with reference to FIG. 19, the parameter adjustment processing in FIG. 20 can be similarly performed. In this case, automatic adjustment can be performed with the pressing force, the insertion speed, and the operating speed of the conveying device as parameters.

As described above, the parameter adjustment processing enables automatic update of parameters in force-controlled centering to suitable values. In this case, in addition to the force control parameters, the operating parameter of the chuck on the principal axis of the machine tool being a machine operating in coordination with the robot in the force-controlled centering can be automatically updated at the same time.

As illustrated in FIG. 14, robot controller 20B may include calculation unit 128 calculating at least part of the force control parameters, based on a predetermined condition related to force control and previously storing the calculated parameters into storage unit 129. For example, based on a cycle time as a condition related to force control, calculation unit 128 can determine the insertion speed V[j] and the chuck closing speed C[k] in such a way as to satisfy the condition. In this case, denoting the cycle time as a condition by Tc, the insertion speed V and the chuck closing speed C may be determined in such a way that, considering the movement distance L₁ of the workpiece and the movement distance L₂ of the chuck, the time required for force control expressed by (L₁/V)+(L₂/C) is equal to or less than the cycle time To as the condition. Calculation unit 128 may determine a plurality of sets of parameters satisfying the condition for the cycle time and store the sets into storage unit 129. Parameter adjustment unit 124B can adjust the parameters by performing the parameter adjustment processing illustrated in FIG. 20 by using the parameters being calculated by calculation unit 128 and being stored in storage unit 129.

A search for proper parameters for parameters related to force control and an operating parameter of a machine operating with the robot, i.e., adjustment to proper parameters can also be performed in the third embodiment.

As described above, each embodiment enables a search for proper parameters for parameters related to force control and an operating parameter of a machine operating with the robot, i.e., adjustment to proper parameters.

The functional blocks of the robot controllers illustrated in FIG. 2, FIG. 9, and FIG. 14 may be provided by the CPU in the robot controller executing various types of software stored in a storage device or may be provided by a configuration mainly based on hardware such as an application specific integrated circuit (ASIC).

Programs executing various types of processing according to the embodiments described above, such as the parameter adjustment processing, may be recorded on various computer-readable recording media (e.g., semiconductor memories such as a ROM, an EEPROM, and a flash memory; a magnetic recording medium; and optical disks such as a CD-ROM and a DVD-ROM).

The function as calculation unit 128 described in the third embodiment described above, i.e., the function of previously calculating at least part of parameters, based on a condition related to force control, may be provided as a function of robot controller 20 according to the first embodiment. In this case, for example, when a condition related to a cycle time of screw fastening is given, at least an initial value of the rotation speed of a screw may be determined based on a pitch of the screw thread of the screw, an amount of depression (a stroke) of the screw, and the like.

Determination unit 125 according to each of the aforementioned embodiments uses a criterion of whether, as a response to force control, the robot is oscillating, or an excessive force is acting on the robot. Whether the time required for work based on force control exceeds a predetermined time (e.g. a cycle time as a condition) may be added as a criterion used by determination unit 125. In this case, for example, determination unit 125 may execute the screw fastening operation with a certain parameter set and, when the time required for completion of the screw fastening exceeds a predetermined time, may determine that the parameter set is not suitable.

While the present disclosure has been described in detail, the present disclosure is not limited to each of the aforementioned embodiments. Various additions, substitutions, changes, partial deletions, and the like may be made to the embodiments without departing from the spirit of the present disclosure or without departing from the scope of the present disclosure derived from the contents described in the claims and the equivalents thereof. Further, the embodiments may be implemented in combination. For example, the operation order or processing order is described as an example in the aforementioned embodiments and is not limited thereto. Further, the above also holds when a numerical value or a mathematical expression is used in the description of the aforementioned embodiments.

The following Supplementary Notes are further disclosed with regard to the aforementioned embodiments and the modified examples thereof.

### Supplementary Note 1

A controller (20, 20A, 20B) for controlling a robot (10, 10A, 10B), the controller (20, 20A, 20B) including:
a force control unit (122) configured to execute force control, based on a detection value of a force detector (70) and a predetermined force control parameter; and
a parameter adjustment unit (124, 124A, 124B) configured to adjust the predetermined force control parameter and an operating parameter of a machine operating with the robot by causing the robot and the machine to execute predetermined work based on the force control and transmit a command value of the adjusted operating parameter to the machine.

### Supplementary Note 2

The controller (20, 20A, 20B) according to Supplementary Note 1, wherein
the parameter adjustment unit (124, 124A, 124B) adjusts the predetermined force control parameter and the operating parameter of the machine by causing the predetermined work to be executed a plurality of times.

### Supplementary Note 3

The controller (20, 20A, 20B) according to Supplementary Note 1 or 2, wherein
the machine is an end effector equipped on the robot (10, 10A, 10B), and
the parameter adjustment unit (124, 124A, 124B) adjusts the predetermined force control parameter and an operating parameter of the end effector.

### Supplementary Note 4

The controller (20, 20A, 20B) according to Supplementary Note 3, wherein
the parameter adjustment unit (124, 124A, 124B) provides at least one of a position error and a posture error of the end effector relative to a work target object and causes the robot and the end effector to execute the predetermined work, and
the force control unit (122) operates in such a way as to correct at least one of the position error and the posture error.

### Supplementary Note 5

The controller (20) according to Supplementary Note 3 or 4, wherein
the predetermined work is screw fastening,
the end effector is a screw fastening mechanism, and
the screw fastening mechanism uses one of a screw fastener (60), an additional axis motor (12A), and a wrist axis (11c) of the robot.

### Supplementary Note 6

The controller (20A) according to Supplementary Note 3 or 4, wherein
the predetermined work is polishing,
the end effector includes a tool (66) for polishing, and
the tool for polishing uses an additional axis motor (12A) or a wrist axis (llc) of the robot.

### Supplementary Note 7

The controller according to Supplementary Note 3 or 4, wherein
the predetermined work is deburring,
the end effector includes a grinder (67) for deburring, and
the grinder (67) uses an additional axis motor (12A) or a wrist axis (11c) of the robot.

### Supplementary Note 8

The controller (20A) according to Supplementary Note 3 or 4, wherein
the predetermined work is friction stir welding,
the end effector includes a rotary tool (68) for friction stir welding, and
the rotary tool (68) uses an additional axis motor (12A) or a wrist axis (11c) of the robot.

### Supplementary Note 9

The controller (20, 20A) according to any one of Supplementary Notes 5 to 8, wherein
the predetermined force control parameter includes a pressing force of the robot and a force control gain, and
the operating parameter of the end effector includes a rotation speed.

### Supplementary Note 10

The controller (20, 20A) according to any one of Supplementary Notes 5 to 9, further including
a load determination unit (127) configured to determine whether a load applied to each axis of the robot (10, 10A) exceeds a predetermined threshold value, wherein
the parameter adjustment unit (124, 124A) performs adjustment of decreasing a rotation speed of the end effector when a load applied to any axis of the robot is determined to exceed the predetermined threshold value by the load determination unit.

### Supplementary Note 11

The controller (20B) according to Supplementary Note 1 or 2, wherein the machine is a machine tool (200),
the parameter adjustment unit (124B) adjusts the predetermined force control parameter and an operating parameter of a chuck in the machine tool by causing work of the robot installing a workpiece on the machine tool by the force control to be executed,
the force control parameter includes a pressing force of the robot (10B) and an operating speed of the robot, and
the operating parameter of the machine includes a closing speed of the chuck. cl Supplementary Note 12

The controller according to Supplementary Note 1 or 2, wherein
the machine includes a machine tool (200) and a hand (69) equipped on the robot,
the parameter adjustment unit (124B) adjusts the predetermined force control parameter and an operating parameter of the hand by causing work of the robot taking out a workpiece installed on the machine tool (200) by using the hand (69) by the force control to be executed,
the force control parameter includes a pressing force of the robot (10B) and an operating speed of the robot, and
the operating parameter of the machine includes a closing speed of the hand.

### Supplementary Note 13

The controller according to Supplementary Note 1 or 2, wherein
the machine is a conveying device (190),
the parameter adjustment unit (124B) adjusts the predetermined force control parameter and an operating parameter of the conveying device by causing work of the robot (10B) fitting a workpiece to a fitted workpiece conveyed on the conveying device (190) by the force control to be executed,
the force control parameter includes a pressing force of the robot (10B) and an operating speed of the robot, and
the operating parameter of the machine includes an operating speed of the conveying device (190).

### Supplementary Note 14

The controller (20, 20A, 20B) according to any one of Supplementary Notes 1 to 13, further including
a determination unit (125) configured to determine an operating state of the force control during execution of the predetermined work, wherein
the parameter adjustment unit (124, 124A, 124B) acquires an adjustment value of the predetermined force control parameter by acquiring a determination result of the operating state while varying a value of the predetermined force control parameter during execution of the predetermined work.

### Supplementary Note 15

The controller (20, 20A, 20B) according to any one of Supplementary Notes 11 to 13, further including:
a storage unit (129) configured to store a plurality of values for each of the predetermined force control parameter and the operating parameter of the machine; and
a determination unit (125) configured to determine an operating state of the force control during execution of the predetermined work, wherein
   the parameter adjustment unit (124, 124A, 124B) executes the predetermined work by using each of the plurality of values related to each of the predetermined force control parameter and the operating parameter of the machine and
   acquires an adjustment value of the predetermined force control parameter and the operating parameter of the machine by acquiring a determination result of the operating state during the predetermined work.

### Supplementary Note 16

The controller (20, 20A, 20B) according to Supplementary Note 14 or 15, wherein
the determination unit (125) determines the operating state, based on a detection value output from the force detector as a response based on the force control.

### Supplementary Note 17

The controller (20, 20A, 20B) according to Supplementary Note 16, wherein
the determination unit (129) determines an operating state of the force control, based on whether the detection value as a response based on the force control exceeds a predetermined threshold value, whether the detection value as a response based on the force control is oscillating, or a time required for the force control.

### Supplementary Note 18)

The controller (20, 20A, 20B) according to Supplementary Note 15, further including
a calculation unit (128) configured to calculate a value of a parameter of at least part of the predetermined force control parameter and the operating parameter of the machine, based on a predetermined condition related to the force control, and store the value into the storage unit.

### Supplementary Note 19

A robot system (100, 100A, 100B) including:
a robot (10, 10A, 10B);
a machine (60, 66, 67, 68, 69, 190, 200) configured to operate with the robot;
a force detector (70) configured to detect a force acting on the robot;
a force control unit (122) configured to execute force control, based on a detection value of the force detector and a predetermined force control parameter; and
a parameter adjustment unit (124, 124A, 124B) configured to adjust the predetermined force control parameter and an operating parameter of the machine by causing the robot and the machine to execute predetermined work based on the force control and transmit a command value of the adjusted operating parameter to the machine.

### REFERENCE SIGNS LIST

10, 10A, 10B Robot
11, 11A Flange
11B Wrist
11c Wrist axis
12A Additional axis motor
20, 20A, 20B Robot controller
30 Teach pendant
51 Attaching plate
60 Screw fastener
61 Body unit
62 Head unit
65 Socket
66 Tool
67 Grinder
68 Rotary tool
69 Hand
70 Force sensor
81 Screw
100, 100A, 100B Robot system
111 Motor
112 Wrist axis motor
121, 121A, 121B Operation control unit
122 Force control unit
123 Force data processing unit
124, 124A, 124B Parameter adjustment unit
125 Determination unit
127 Load determination unit
128 Calculation unit
129 Storage unit
161 Control unit
162 Motor
190 Conveying device
200 Machine tool
201 Principal axis
210 Control unit
220 Chuck

1. A controller for controlling a robot, the controller comprising:
a force control unit configured to execute force control, based on a detection value of a force detector and a predetermined force control parameter; and
a parameter adjustment unit configured to adjust the predetermined force control parameter and an operating parameter of a machine operating with the robot by causing the robot and the machine to execute predetermined work based on the force control and transmit a command value of the adjusted operating parameter to the machine.

2. The controller according to claim 1, wherein
the parameter adjustment unit adjusts the predetermined force control parameter and the operating parameter of the machine by causing the predetermined work to be executed a plurality of times.

3. The controller according to claim 1, wherein
the machine is an end effector equipped on the robot, and
the parameter adjustment unit adjusts the predetermined force control parameter and an operating parameter of the end effector.

4. The controller according to claim 3, wherein
the parameter adjustment unit provides at least one of a position error and a posture error of the end effector relative to a work target object and causes the robot and the end effector to execute the predetermined work, and
the force control unit operates in such a way as to correct at least one of the position error and the posture error.

5. The controller according to claim 3, wherein
the predetermined work is screw fastening,
the end effector is a screw fastening mechanism, and
the screw fastening mechanism uses one of a screw fastener, an additional axis motor, and a wrist axis of the robot.

6. The controller according to claim 3, wherein
the predetermined work is polishing,
the end effector includes a tool for polishing, and
the tool for polishing uses an additional axis motor or a wrist axis of the robot.

7. The controller according to claim 3, wherein
the predetermined work is deburring,
the end effector includes a grinder for deburring, and
the grinder uses an additional axis motor or a wrist axis of the robot.

8. The controller according to claim 3, wherein the predetermined work is friction stir welding,
the end effector includes a rotary tool for friction stir welding, and
the rotary tool uses an additional axis motor or a wrist axis of the robot.

9. The controller according to claim 5, wherein
the predetermined force control parameter includes a pressing force of the robot and a force control gain, and
the operating parameter of the end effector includes a rotation speed.

10. The controller according to claim 5, further comprising
a load determination unit configured to determine whether a load applied to each axis of the robot exceeds a predetermined threshold value, wherein
the parameter adjustment unit performs adjustment of decreasing a rotation speed of the end effector when a load applied to any axis of the robot is determined to exceed the predetermined threshold value by the load determination unit.

11. The controller according to claim 1, wherein
the machine is a machine tool,
the parameter adjustment unit adjusts the predetermined force control parameter and an operating parameter of a chuck in the machine tool by causing work of the robot installing a workpiece on the machine tool by the force control to be executed,
the force control parameter includes a pressing force of the robot and an operating speed of the robot, and
the operating parameter of the machine includes a closing speed of the chuck.

12. The controller according to claim 1, wherein
the machine includes a machine tool and a hand equipped on the robot,
the parameter adjustment unit adjusts the predetermined force control parameter and an operating parameter of the hand by causing work of the robot taking out a workpiece installed on the machine tool by using the hand by the force control to be executed,
the force control parameter includes a pressing force of the robot and an operating speed of the robot, and
the operating parameter of the machine includes a closing speed of the hand.

13. The controller according to claim 1, wherein
the machine is a conveying device,
the parameter adjustment unit adjusts the predetermined force control parameter and an operating parameter of the conveying device by causing work of the robot fitting a workpiece to a fitted workpiece conveyed on the conveying device by the force control to be executed,
the force control parameter includes a pressing force of the robot and an operating speed of the robot, and
the operating parameter of the machine includes an operating speed of the conveying device.

14. The controller according to claim 1, further comprising
a determination unit configured to determine an operating state of the force control during execution of the predetermined work, wherein
the parameter adjustment unit acquires an adjustment value of the predetermined force control parameter by acquiring a determination result of the operating state while varying a value of the predetermined force control parameter during execution of the predetermined work.

15. The controller according to claim 11, further comprising:
a storage unit configured to store a plurality of values for each of the predetermined force control parameter and the operating parameter of the machine; and
a determination unit configured to determine an operating state of the force control during execution of the predetermined work, wherein
the parameter adjustment unit
executes the predetermined work by using each of the plurality of values related to each of the predetermined force control parameter and the operating parameter of the machine, and
acquires an adjustment value of the predetermined force control parameter and the operating parameter of the machine by acquiring a determination result of the operating state during the predetermined work.

16. The controller according to claim 14, wherein
the determination unit determines the operating state, based on a detection value output from the force detector as a response based on the force control.

17. The controller according to claim 16, wherein
the determination unit determines an operating state of the force control, based on whether the detection value as a response based on the force control exceeds a predetermined threshold value, whether the detection value as a response based on the force control is oscillating, or a time required for the force control.

18. The controller according to claim 15, further comprising
a calculation unit configured to calculate a value of a parameter of at least part of the predetermined force control parameter and the operating parameter of the machine, based on a predetermined condition related to the force control, and store the value into the storage unit.

19. A robot system comprising:
a robot;
a machine configured to operate with the robot;
a force detector configured to detect a force acting on the robot;
a force control unit configured to execute force control, based on a detection value of the force detector and a predetermined force control parameter; and
a parameter adjustment unit configured to adjust the predetermined force control parameter and an operating parameter of the machine by causing the robot and the machine to execute predetermined work based on the force control and transmit a command value of the adjusted operating parameter to the machine.
